(19) United States
(12) Patent Application Publication
(10) Pub. No.: US 2009/0098376 A1
(43) Pub. Date: Apr. 16, 2009

(54) Double-Sided Adhesive Tape for Securing Polishing-Pad

(76) Inventor: Yoshiyuki Fukuoka, Hyogo (JP)

Correspondence Address: WENDEROTH, LIND & PONACK, L.L.P., 2033 K STREET N. W., SUITE 800, WASHINGTON, DC, 20006-1021, US

(21) Appl. No.: 12/227,409

(22) PCT Filed: May 16, 2007
(86) PCT No.: PCT/JP2007/060015

§ 371 Date: Nov. 17, 2008

(30) Foreign Application Priority Data
May 17, 2006 (JP) 2006-137681

(51) Int. Cl. B32B 27/08

(52) U.S. Cl. 428/337

(57) ABSTRACT

To provide a double-sided adhesive tape for securing a polishing-pad, the tape being capable of improving precision in polishing using a polishing-pad.

The double-sided adhesive tape 1 for securing the polishing-pad includes a substrate 2 and adhesive layers 3 and 4, which are provided on both sides of the substrate 2, respectively. The substrate 2 is formed of a polyethylene terephthalate resin-film having a thickness of 150 to 300 μm, one of the adhesive layer 3 is formed of a synthetic rubber pressure sensitive adhesive, and the other adhesive layer 4 is formed of an acrylic solvent-based pressure sensitive adhesive.

### TECHNICAL FIELD

The present invention relates to a double-sided adhesive tape for securing a polishing-pad on a platen of a polishing apparatus for polishing a semiconductor wafer or the like.

### BACKGROUND ART

The more wiring of a semiconductor integrated circuit increased in refinement in order to get higher density of integration, the more unevenness of surfaces in a semiconductor wafer and a liquid crystal glass substrate needs to be made as flat as possible. Accordingly, a Chemical Mechanical Polishing method (hereinafter referred to as a CMP method) has been adopted (see Patent document 1, for example).

In the CMP method, a polishing-pad is secured onto a horizontally disposed platen of a polishing apparatus by using a pressure-sensitive adhesive tape and a wafer is placed on the polishing-pad, the platen and the wafer are rotated or slid relatively to each other while polishing slurry is dripped onto the polishing-pad, whereby the one side of the wafer in contact with the polishing-pad is abraded.

Since various polishing reagents are used at the time of polishing with such polishing-pads, as a pressure-sensitive adhesive tape for securing a polishing-pad on the platen, such a double-sided adhesive tape that is composed of highly chemical-resistant polyethylene terephthalate as its substrate and is composed of pressure-sensitive adhesive layers provided on both sides of the base, is used. (see Patent document 2, for example).

However, when polishing was performed using a polishing-pad secured with the conventional double-sided adhesive tape, there has been a problem of poor polishing precision.
Patent document 1: Laid-Open Japanese Patent Publication No. 2001-287154
Patent document 2: Laid-Open Japanese Patent Publication No. 2003-171631

### DISCLOSURE OF THE INVENTION

In view of the above-described problem, an object of the present invention is to provide a double-sided adhesive tape for securing a polishing-pad, the tape according to the present invention having greatly improved on the precision in polishing using a polishing-pad.

In order to attain the above-described object, an inventor of the present invention studied this problem in detail, and has found that poor precision in polishing is caused by the fact that a polishing-pad, particularly the outer edge of the polishing-pad is distorted by polishing pressure. As a result of further studies, the inventor has found that if the properties of material and the thickness of the substrate of the double-sided adhesive tape for securing the polishing-pad are adjusted, it is possible to improve polishing performance by suppressing the adverse effect of the polishing pressure on the polishing-pad, and consequently, the inventor has arrived at the present invention.

That is, the double-sided adhesive tape for securing the polishing-pad (hereinafter simply referred to as “double-sided tape”) according to the present invention comprises a substrate and adhesive layers which are provided respectively on both sides of the substrate, wherein the thickness of the substrate formed of a polyethylene terephthalate resin-film ranges from 150 μm to 300 μm.

A shape of the double-sided tape of the present invention may be, but not limited to, a rolled-up long strip shape, a short strip shape, and a rectangular or a circle sheet shape.

In the double-sided adhesive tape according to the present invention, as its support sheet, i.e. substrate, a polyethylene terephthalate resin-film can be used exclusively because of its good resistance to chemical attack. Additionally, the thickness of the substrate for a double-sided adhesive tape ranges from 150 μm to 300 μm is exclusively used, because, in forming the support sheet, providing that the thickness of the substrate is less than 150 μm, there is not enough of improvements in abrasive precision, otherwise it exceeds 300 μm, there is any cause for trouble in properties of mounting it on a polishing-pad, productivity of it and the like. Further, the surface of the substrate is preferably undergoing surface preparation which helps to improve bond properties, exemplary, easy bonding process. Such surface preparation includes corona discharge treatment, primer coating so as to increase wetting properties and so on; but those are not particularly limited thereto.

The adhesive layer of the double-sided tape according to the present invention is preferable to be made of a pressure sensitive adhesive, a hot-melt adhesive, or the like, but such adhesives being not necessarily limited thoseto.

Examples of the pressure sensitive adhesive include an acrylic pressure sensitive adhesive, a rubber-based pressure sensitive adhesive, a polyurethane resin pressure sensitive adhesive, a silicone resin pressure sensitive adhesive and the like, but such adhesives being not necessarily limited thoseto. Preferably, at least one of the adhesive layers is formed of a synthetic rubber pressure sensitive adhesive, and the other adhesive layer may be formed of the acrylic resin pressure sensitive adhesive. In the case where one of the adhesive layers is formed of the synthetic rubber pressure sensitive adhesive and the other adhesive layer is formed of the acrylic resin pressure sensitive adhesive, then it is preferable that the synthetic rubber pressure sensitive adhesive layer is bonded on a polishing-pad and the acrylic solvent-based pressure sensitive adhesive layer is bonded on the platen of the polishing apparatus.

As the above-described synthetic rubber pressure sensitive adhesive, a commonly used compound mainly composed of synthetic rubber, tack resin or the like can be used. Examples of the adhesives in such synthetic rubber adhesives include styrene-butadiene rubber (SBR), polyisoprene rubber (IR), polyisobutylene (PIB), butyl rubber (IIR), and the like.

Examples of resins in such tack resins include natural products such as rosin resin, terpene resin, and derivatives thereof; and synthetic resin such as aliphatic petroleum resin, alicyclic petroleum resin, aromatic petroleum resin, coumarone-indene resin, styrene resin, phenolic resin, xylene resin, and the like. These kinds of tack resin may be used alone or in combination of two or more thereof.

As the synthetic rubber-based pressure sensitive adhesive, it may be blended with organic peroxides such as, for example, tert-butylhydroperoxide, 1,1,3,3-tetramethyl-butylhydroperoxide, p-methane hydroperoxide, cumene hydroperoxide, di-isopropyl benzen hydroperoxide, 2,5-dimethyl hexane-2,5-dihydroperoxide, di-tert-butyl peroxide, dicumyl peroxide, tert-butyl cumyl peroxide, 1,1-bis(tert-butylperoxy)-cyclododecane, 2,2-bis(tert-butylperoxy)octane, 1,1-di-tert-butylperoxy cyclohexane, 2,5-dimethyl-2,5-di(tert-butylperoxy)hexane, 2,5-dimethyl-2,5(tert-butylperoxy)hexyne-3, 1,3-bis(tert-butylperoxy isopropyl)benzen, 2,5-dimethyl-2,5-di(benzoylperoxy)hexane, 1,1-bis(tert-butylperoxy)-3,3,5-trimethyl cyclohexane, n-butyl-4,4-bis(tert-butylperoxy)valerate, benzoyl peroxide, m-toluyl peroxide, p-chlorobenzoyl peroxide, 2,4-dichlorobenzoyl peroxide, tert-butylperoxy isobutyrate, tert-butylperoxy-2-ethyl hexanoate, tert-butylperoxy benzoate, tert-butylperoxy isopropyl carbonate, tert-butylperoxy allyl carbonate, or the like.

Examples of adhesives in said pressure sensitive adhesives include an acrylic pressure sensitive adhesives employing as the base polymer a (meth)acrylate ester monomer derived from alcohol having an alkyl group of 4 to 12 carbon atoms, a (meth)acrylate ester homopolymer or copolymer having an alkyl group of 4 to 12 carbon atoms preferably, or an acrylic copolymer composed of such a (meth)acrylate ester monomers as mentioned above and a copolymer is polymerizable with the (meth)acrylate ester monomer. In the present invention, the (meth)acrylate is referred to designation as acrylate or methacrylate.

Examples of the (meth)acrylate ester monomer having the alkyl group of 4 to 12 carbon atoms include, but that being not necessarily limited, n-butyl (meth)acrylate, 2-ethylhexyl (meth)acrylate, isooctyl (meth)acrylate, n-octyl (meth)acrylate, isononyl (meth)acrylate, lauryl (meth)acrylate and the like. These polymers may be used alone or in combination of two or more thereof. Further, in order to obtain a pressure sensitive adhesive having a good adhesion properties, an appropriate compatibility of adhesiveness with cohesiveness and the like, preferably used in general as its primary component, a (meth)acrylate alkyl ester having a glass transition temperature (Tg) of −50° C. or lower, as well as alternatively mixed with a (meth)acrylate ester composed of a lower alcohol such as, for example, methyl (meth)acrylate, ethyl (meth)acrylate or the like.

Further, as any other polimerizaible monomers except for said vinyl monomers can be used a monomer including a carboxyl group such as, for example, (meth)acrylate, maleic acid, fumaric acid, itaconic acid, or the like, as well as anhydrides thereof, or a monomer including a hydroxyl group such as, for example, 2-hydroxy ethyl (meth)acrylate, 4-hydroxy butyl acrylate, polyoxyethylene (meth)acrylate, polyoxypropylene (meth)acrylate, caprolactone-modified (meth)acrylate or the like.

In the case of forming the adhesive layer using the pressure sensitive adhesive, the thickness thereof is preferably selected in the range of from 25 to 75 μm, but the thickness is not limited to those.

If the thickness of the adhesive layer is less than 25 μm, there is a fear that the adhesive layer will break off from the platen during polishing. On the other hand, if the thickness of the adhesive layer exceeds 75 μm, adhesive deposit may be made on the platen at the time of removing the adhesive layer after polishing.

As the hot-melt adhesive can be preferably employed a synthetic rubber-based hot-melt adhesive, but it is not particularly limited to these.

Examples of the synthetic rubber-based hot-melt adhesive include, but being not particularly limited to these, a diene type (butadiene, styrene-butadiene, chloroprene, butadiene-acrylonitrile), a non-diene type (isobutylene-isoprene, ethylene-propylene, or the like), and a thermoplastic type (also referred to as thermoplastic elastomer such as styrene, olefins, esters, and urethanes), and preferably a melting temperature of the synthetic rubber-based hot-melt adhesive is in a range of from 75° C. to 120° C. (more preferably a range of from 80° C. to 110° C.). In consideration of the melting temperature range, the thermoplastic type can be advantageously employed.

In that case, if the melting temperature is less than 75° C., a well anchoring effect cannot be obtained against unevenness of a surface of a rigid urethane sheet. On the other hand, if the melting temperature exceeds 120° C., a problem will be caused in that the polyethylene is foamed in release sheet which is to be described later.

As such synthetic rubber-based hot-melt adhesive having a melting temperature in the range of from 75° C. to 120° C., can be used a commercially available material such as a styrene block copolymer (product name, AZ5001) produced by Asahi Chemical Synthetic Co., Ltd. in Japan.

In the case where the adhesive layer is formed of the synthetic rubber-based hot-melt adhesive, a thickness of the first adhesive layer is preferably is selected in the range of 30 μm to 120 μm, but the thickness is not limited to those.

If the thickness of the adhesive layer formed of the synthetic rubber-based hot-melt adhesive is less than 30 μm, a well adhesive strength may not be expected. On the other hand, if the thickness exceeds 120 μm and more, it may not be provided precision accuracy in coating thickness.

Further, if necessary, various additive agents such as, for example, a tackiness adding agent, an inorganic or an organic filler, an antioxidant (anti aging agent), a heat stabilizer, a light stabilizer, an ultraviolet absorber or the like may be added to or contained in the above-identified pressure sensitive adhesive, etc.

In the double-sided adhesive tape for fixing a polishing-pad according to the present invention, a release medium is preferably attached to the adhesive layer thereof. Examples of such release medium include a release sheet or release film which is produced by applying release-coating to at least one side of the paper or film, in which the release-coating is formed of silicone resin, long-chain alkyl pendant graft polymer or the like. However, the release medium is particularly limited to the samples as mentioned above.

As the polishing-pad secured to one side of the double-sided tape according to the present invention can be used a block made of material such as, for example, a rigid polyurethane foam, various types of rubber foams, an olefin-based resin foam such as polyethylene, polypropylene and the like, a sliced slab stock made of these types of foams having an average particle diameter of 0.5 mm or more as well as containing an abrasive grain such as cerium, or silica, a filler, a polishing agent, or the like, etc.

As above described, the double-sided tape for securing a polishing-pad according to the present invention is composed of a substrate made of a polyethylene terephthalate film having the thickness in the range of from 150 μm to 300 μm so that the polishing pad is possible to minimize strain caused by the pressure applied thereto in polishing, whereby the pad is sustainable of a high precision accuracy in polishing over a long period of the time, and further the double-sided tape is possible to hold the polishing pad in a stable state on account of a high chemical resistance for a long period of time.

### BRIEF DESCRIPTION OF THE DRAWINGS

FIG. 1 is a cross-sectional view showing one embodiment of a double-sided tape for securing a polishing-pad according to the present invention.

### BEST MODES FOR CARRYING OUT THE INVENTION

Embodiments of the present invention will be hereinafter described in detail with reference to the accompanying drawings.

Hereinafter, an embodiment of the present invention will be described in detail with referring to the following accompanied drawing.

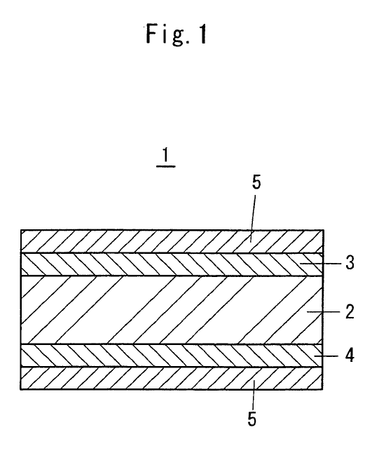

FIG. 1 is a diagram showing one embodiment of a double-sided tape for fixing a polishing-pad according to the present invention.

As shown in FIG. 1, a double-sided tape 1 comprises a substrate 2, wherein a first adhesive layer 3 is laminated on one side of the substrate 2 and a second adhesive layer 4 is laminated on the other side thereof as well. Each release sheet 5 is laminated on one surface or side of the respective adhesive layers 3 and 4.

The substrate 2 is formed from a polyethylene terephthalate resin-film having a thickness of 150 to 300 μm, both sides of the polyethylene terephthalate resin-film having undergone an adhesion improved treatment such as, for example, corona discharge treatment.

The first adhesive layer 3 is made of a synthetic rubber pressure sensitive adhesive.

The second adhesive layer 4 is made of an acrylic solvent-based pressure sensitive adhesive.

The release sheet 5 is formed by using a polyethylene terephthalate resin-film as the substrate, both sides thereof having undergone pretreatment of a coating with silane coupling agent.

Each release sheets 5 is removed from both sides of the double-sided tape 1, and then a first adhesive layer 3 on one side of the double-face tape 1 being pressed and bonded onto a polishing-pad (not shown), a second adhesive layer 4 on the other side of the same being pressed and bonded onto a platen as well.

The above-said double-sided tape 1 may be manufactured as follows.

At first, a pair of release sheets 5 is formed according to the steps, in which a deposit of a synthesized rubber adhesive solvent on a side of the first release sheet 5 is formed in a determined overall thickness thereof, and then it is dried, whereby the first adhesive layer 3 is formed, and a deposit of a synthesized rubber adhesive solvent on a side of a second release sheet 5 is formed in a determined overall thickness thereof and thereafter it is dried, whereby the second adhesive layer 4 is formed.

Next, on one side of a substrate 2, the pressure sensitive adhesive side of the first adhesive layer 3 is pressed, similarly on the other side of the substrate 2, the pressure sensitive adhesive side of the second adhesive layer 4 being pressed.

Hereinafter, the present invention will be described in further details with reference to examples, however, the present invention is not limited to the following examples.

### EXAMPLE 1

A release sheet 5 (release sheet 75S-518LA made by Fujimori Kogyo Co., Ltd.) is coated with a synthetic rubber pressure sensitive adhesive (DCL made by Sekisui Chemical Co., Ltd.) to be formed a first adhesive layer 3 having a overall thickness of 40 μm after having been dried out of solvent with heating of it at 100° C. for three minutes, whereby a first laminated material, that is, the release sheet 5 having the first adhesive layer 3 attached on one side thereof, is obtained.

Both sides of a polyethylene terephthalate resin-film (made by Teijin Limited) having a thickness of 250 μm are subjected to corona discharge treatment, whereby the substrate 2 is produced.

One side of the substrate 2 is coated with a compound made by mixing 100 parts by weight of an acrylate ester copolymer (WHD made by Sekisui Chemical Co., Ltd.) with 1.5 parts by weight of an isocyanate-based cross-linking agent (Coronate L-55E made by Nippon Polyurethane Industry Co., Ltd.) so as to be formed of deposit of 50 μm thickness after having been dried out of solvent with heating in an oven at 100° C. for three minutes, whereby a second laminated material, that is, the substrate 2 having the second adhesive layer 4 attached on one side thereof, is produced.

Next, the release sheet (release sheet 75S-518LA made by Fujimori Kogyo Co., Ltd.) 5 is laminated on a side of the second adhesive layer 4, and the first adhesive layer 3 side of the first laminated material having been obtained is laminated on a substrate 2 side of the second laminated material, whereby the double-sided tape 1 is produced.

### EXAMPLE 2

A double-sided tape is obtained in the same manner as example 1, except that a polyethylene terephthalate film (made by Teijin Limited) having a thickness of 188 μm is used as the substrate, instead of the polyethylene terephthalate film having the thickness of 150 μm.

### EXAMPLE 3

A double-sided tape is obtained in the same manner as example 1, except that a polyethylene terephthalate resin-film (made by Teijin Limited) having a thickness of 250 μm is used as the substrate, instead of the polyethylene terephthalate resin-film having the thickness of 150 μm.

### EXAMPLE 4

A double-sided tape is obtained in the same manner as example 1, except that a polyethylene terephthalate resin-film (Melinex 238 in opaque white color made by Teijin DuPont Films Japan Limited) having the thickness of 300 μm is used as the substrate, instead of the polyethylene terephthalate resin-film having the thickness of 150 μm.

### COMPARATIVE EXAMPLE 1

A double-sided tape is obtained in the same manner as example 1, except that a polyethylene terephthalate resin-film (made by Teijin Limited) having the thickness of 100 μm is used as the substrate, instead of the polyethylene terephthalate resin-film having the thickness of 250 μm.

### COMPARATIVE EXAMPLE 2

A double-sided tape is obtained in the same manner as example 1, except that a polyethylene terephthalate resin-film (Melinex S made by Teijin DuPont Films Japan Limited) having a thickness of 125 μm is used as the substrate, instead of the polyethylene terephthalate film having the thickness of 250 μm.

### COMPARATIVE EXAMPLE 3

A double-sided tape is obtained in the same manner as example 1, except that a polyethylene terephthalate resin-film (made by Teijin Limited) having a thickness of 500 μm is used as the substrate, instead of the polyethylene terephthalate resin-film having the thickness of 250 μm.

With regard to each of the double-sided tapes obtained in above-described examples 1 to 4 and comparative examples 1 to 3, precision in polishing, suitability for processing, and ease of work are evaluated as follows, and the result is shown in Table 1.

(Precision in Polishing)

The release sheet 5 on the first adhesive layer 3 side of the double-sided tape 1 is removed, and a rigid urethane resin pad including cerium oxide (made by Toray Industries, Inc.) is placed on another rigid urethane resin pad including cerium oxide (made by Toray Industries, Inc.). A rubber roll is placed on the release sheet 5 on the second adhesive layer 4 side, and rolled thereon under a pressure of 4 kg/cm², at a speed of 0.8 m/min, whereby the rigid urethane resin pads are laminated on the double-sided tape 1. The release sheet 5 on the second adhesive layer 4 side is then removed, and the second adhesive layer 4 is laid on a platen of a semiconductor polishing apparatus (made by Ebara Corporation). A rubber roller is placed and rolled on a rigid urethane resin pad side of the second adhesive layer 4 under a pressure of 4 kg/cm², at a speed of 0.8 m/min, whereby the rigid urethane resin pad is secured onto the platen via the double-sided tape 1.

The results of the generating a semiconductor wafer ground by the polishing apparatus were expressed by three kinds of marks, where the mark “⊚” denotes that it is a full-perfect precision accuracy in the polishing, the mark “◯” denoting that it is a good precision accuracy therein, whereas the mark “×” denoting that it is a no-good precision accuracy therein.

(Suitability for Processing)

As to the results of the generating an edge profile of semiconductor wafer ground by the apparatus employing a circle-shaped polishing-pad, the mark “⊚” denotes that it is a extremely good finish in the edge profile, the mark “◯” denoting that it is a good finish therein, whereas the mark “×” denoting that it is no good finish therein.

(Ability for Easy Working)

As to the results of the securing a polishing-pad of the apparatus onto the platen by means of a rubber roll, the mark “◯” denotes that it is a good performance in easy fixing as well as easy removal of the pad, whereas the mark “×” denoting that it is any difficulty therein.

TABLE

| | Thickness | Precision | Suitability | Ease |
|---|---|---|---|---|
| | of base | in | for | of |
| | Material | polishing | processing | work |
| Example 1 | 150 μm | ◯ | ◯ | ◯ |
| Example 2 | 188 μm | ◯ | ◯ | ◯ |
| Example 3 | 250 μm | ⊚ | ⊚ | ◯ |
| Example 4 | 300 μm | ◯ | ◯ | ◯ |
| Comparative | 100 μm | X | ◯ | ◯ |
| Example 1 | | | | |
| Comparative | 125 μm | X | ◯ | ◯ |
| Example 2 | | | | |
| Comparative | 500 μm | ◯ | X | X |
| Example 2 | | | | |

1. A double-sided adhesive tape for securing a polishing-pad comprising:
a substrate; and
adhesive layers respectively provided on both sides of the substrate,
wherein the thickness of the substrate formed of a polyethylene terephthalate film ranges from 150 μm to 300 μm.

2. The double-sided adhesive tape for securing the polishing-pad according to claim 1, wherein one of the adhesive layers is formed of a synthetic rubber adhesive, and the other adhesive layer is formed of an acrylic solvent-based adhesive.
